(19) United States
(12) Patent Application Publication
(10) Pub. No.: US 2010/0121971 A1
(43) Pub. Date: May 13, 2010

(54) MULTIPATH TRANSMISSION OF THREE-DIMENSIONAL VIDEO INFORMATION IN WIRELESS COMMUNICATION SYSTEMS

(75) Inventors: Huai-Rong Shao, Santa Clara, CA (US); Chiu Ngo, San Francisco, CA (US)

Correspondence Address: Myers Andras Sherman LLP, 19900 MacArthur Blvd., Suite 1150, Irvine, CA, 92612, US

(73) Assignee: Samsung Electronics Co., Ltd., Suwon City (KR)

(21) Appl. No.: 12/538,047

(22) Filed: Aug. 7, 2009

Related U.S. Application Data
(60) Provisional application No. 61/113,095, filed on Nov. 10, 2008.

(51) Int. Cl. G06F 15/16; G06F 3/00

(52) U.S. Cl. 709/231; 715/704

(57) ABSTRACT

A method and system for transmitting plural synchronous video streams over multiple wireless paths, is provided. One implementation involves, for each video stream, partitioning spatially correlated pixels into different partitions, and placing pixels from different partitions into different packets. Then, performing multipath transmission of the plural video streams by alternating transmission of packets from each video stream over multiple paths, while maintaining video information for the plural video streams synchronized during transmission.

### RELATED APPLICATION

This application claims priority from U.S. Provisional Patent Application Ser. No. 61/113,095 filed on Nov. 10, 2008, incorporated herein by reference.

### FIELD OF THE INVENTION

The present invention relates in general to wireless communication, and in particular, to wireless transmission of video information.

### BACKGROUND OF THE INVENTION

Three-dimensional (3D) video information typically includes at least two video streams: a left-eye view stream and a right-eye view stream. Conventional video standards such as MPEG4 define the format of 3D video in which multiple compressed video sub-streams are multiplexed together as one video stream. With this type of stream format, 3D video is typically transmitted on a single wireless path. However, if the single path is blocked the 3D video transmission ceases completely.

### BRIEF SUMMARY OF THE INVENTION

A method and system for transmitting plural synchronous video streams over multiple wireless paths, is provided. One implementation involves, for each video stream, partitioning spatially correlated pixels into different partitions, and placing pixels from different partitions into different packets. Then, performing multipath transmission of the plural video streams by alternating transmission of packets from each video stream over multiple paths, while maintaining video information for the plural video streams synchronized during transmission.

These and other features, aspects and advantages of the present invention will become understood with reference to the following description, appended claims and accompanying figures.

### BRIEF DESCRIPTION OF THE DRAWINGS

FIG. 1 shows a wireless transmitter and a receiver in a video streaming wireless system, according to an embodiment of the present invention.

FIG. 2 shows a wireless transmitter and a receiver implementing multipath 3D video streaming, according to an embodiment of the present invention.

FIG. 3 shows a wireless transmitter and a receiver implementing multipath 3D video packet streaming, according to an embodiment of the present invention.

FIG. 4 shows a wireless transmitter and a receiver implementing multipath switching for transmission of video information, according to an embodiment of the present invention.

FIG. 5 shows a block diagram of a wireless transmitter and a receiver implementing multipath switching for transmission of video information, according to an embodiment of the present invention.

FIG. 6 shows a structure of a packet, according to an embodiment of the invention.

FIG. 7 shows a two path transmission example according to an embodiment of the invention, illustrating how the video stream packets are scheduled based on transmission rate adaptation when the bandwidth of one path is halved.

FIG. 8 shows an example of overall communication processes performed by the transmitter and the receiver involving simultaneous multipath wireless communication process for wireless communication of 3D video information, according to an embodiment of the invention.

FIG. 9 shows an example of video frame pixel packetization at the transmitter and de-packetization at the receiver, involved in the simultaneous multipath communication process for wireless communication of 3D video information, according to an embodiment of the invention.

FIG. 10 shows an example of spatial partitioning of pixels into four partition packets, according to an embodiment of the present invention.

### DESCRIPTION OF THE INVENTION

The present invention provides multipath transmission of three-dimensional (3D) video information in wireless communication systems. 3D video information typically includes multiple video streams (e.g., at least two video streams: a left-eye view stream and a right-eye view stream). Wireless transmission of 3D video information according to an embodiment of the invention involves synchronizing the multiple streams and maintaining the same quality during transmission and playback of 3D video information. The multiple streams are synchronized during transmission while providing substantially the same video quality when wireless transmission link quality at one or multiple paths is degraded. In one implementation, multiple 3D video streams are transmitted over a millimeter wave wireless (mmWave) medium while meeting Quality of Service (QoS) requirements for 3D video.

In one example, two uncompressed video streams, one corresponding to the left-eye view and another to the right-eye view, are strictly synchronized during simultaneous multipath transmission process, and during playback. Scalable link adaptation is utilized without negatively affecting synchronization between the two streams. The simultaneous multipath transmission process is resilient to the temporary blockage of one path of the multipath. The streams maintain essentially the same video quality when link quality at one or more paths is degraded. A simultaneous (parallel) multipath transmission process according to the invention is applicable to uncompressed 3D video and compressed 3D video.

Compared to non-3D video, there are two specific requirements for 3D video transmission: (1) the multiple video streams are synchronized during wireless transmission and (2) the multiple streams are synchronized during playback (e.g., display).

According to the simultaneous multipath transmission process, the video streams are alternatively transmitted at different paths to maintain the synchronization of multiple streams and keep similar quality for multiple streams. Synchronization of the streams is maintained via alternating transmission and adaptation schemes. One implementation involves alternating transmission of two or more video streams (whether compressed or uncompressed) via two or more transmission paths. The uncompressed video segments are packetized and sent as streams through alternating transmissions with adaptation when link quality at one or multiple paths is degraded.

Multiple streams are synchronized during wireless transmission from a wireless transmitter, and during playback at a wireless receiver. For example, at time t, if the kth line of the ith video frame of the left-eye stream is being played backed at the receiver, then the kth line of the ith video frame of the right-eye stream must be played backed at the receiver at the same time.

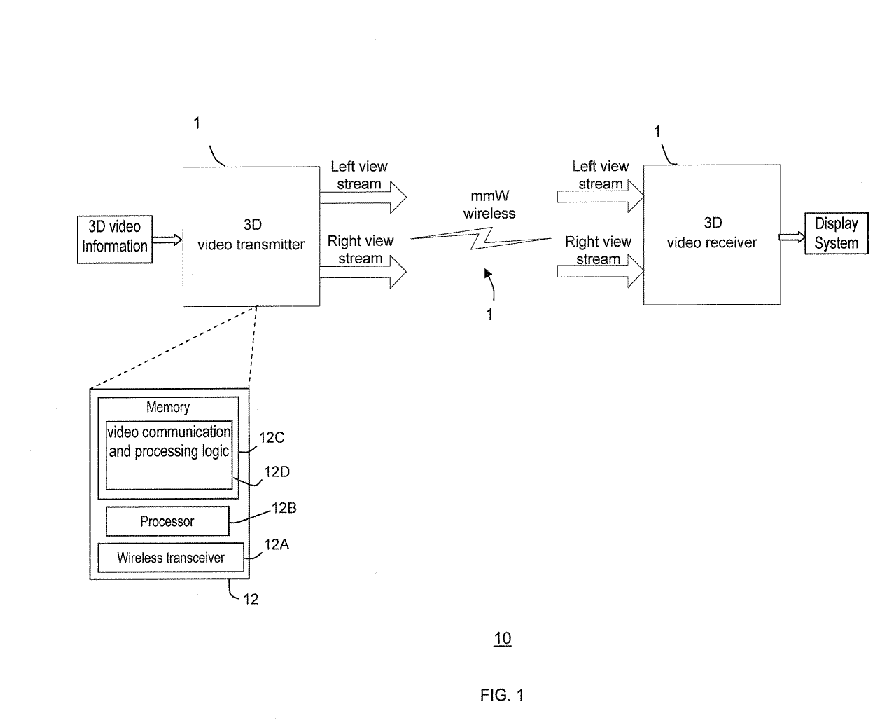

FIG. 1 shows a functional block diagram of a wireless system 10 for wireless transmission of 3D video over a wireless communication medium 11, such as 60 GHz wireless medium (e.g., radio frequency (RF)), from a transmitting wireless station 12 to a receiving wireless station 13, according to an embodiment of the invention. In this example the 3D video comprises uncompressed digital 3D video information. In one embodiment, the transmitting wireless station 12 may comprise a wireless transceiver 12A, a processor 12B and memory 12C including video communication and processing logic 12D, according to an embodiment of the invention. The logic 12D is described according to embodiments of the invention further below. The receiving wireless station 13 comprises similar components (not shown) as that of the transmitting wireless station 12.

The transmitting wireless station 12 (e.g., 3D video transmitter (TX)) transmits two individual streams and the receiving wireless station 13 (e.g., 3D video receiver (RX)) combines and displays the two streams on a 3D display system. As noted, compared to non-3D video, for 3D video transmission the multiple video streams are synchronized during wireless transmission and during display.

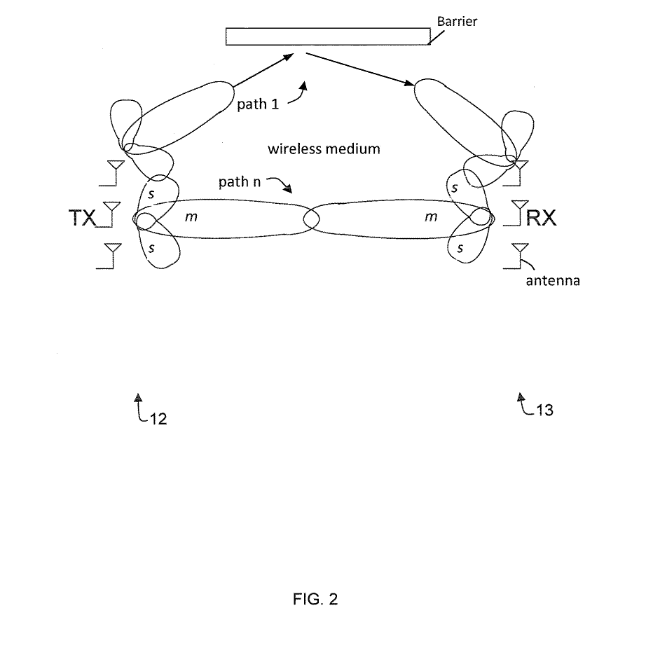

As shown by example in FIG. 2, multipath transmission is used between the transmitter 12 and the receiver 13 where there are multiple spatially separated paths for the same video transmission application, according to an embodiment of the invention. Multipath antenna technologies to support uncompressed 3D video transmission on 60 GHz wireless channels include polarized antenna, Multiple-Input Multiple-Output (MIMO), Multibeam Antenna Array, and multiple sectored antennas. FIG. 2 shows example multipath directional transmissions using beamforming, between the transmitter 12 and the receiver 13. The wireless signals comprise directional beam signals, each directional beam (i.e., path) comprises a main lobe m and side lobes s.

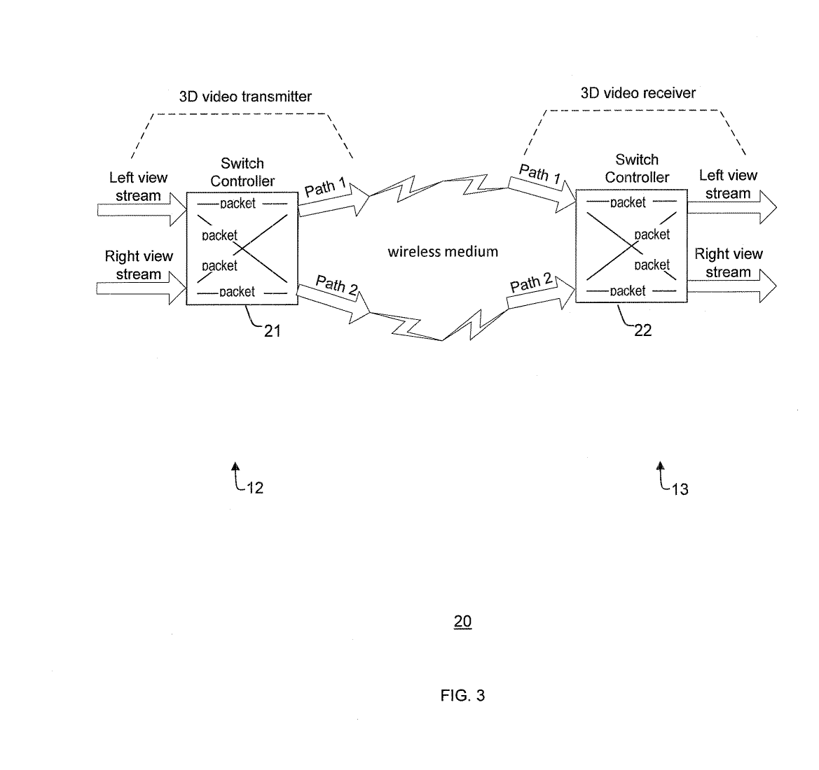

FIG. 3 shows an example multipath transmission system 20 comprising the wireless transmitter 12 and wireless receiver 13, for transmission of uncompressed 3D video, according to an embodiment of the invention. The transmitter 12 implements a switch controller 21 (e.g., software/hardware logic) and the receiver 13 implements a switch controller 22 (e.g., software/hardware logic). The switch controllers 21 and 22 are configured for communicating two or more streams (i.e., Left view stream and Right view stream) at multiple paths (i.e., Path 1 and Path 2), alternately, between the transmitter 12 and the receiver 13. In general, different paths may have same bandwidth capacities/capabilities.

In this example, the switch controller 21 at the transmitter schedules portions (e.g., packets) of the two video streams for alternate transmission at two transmission paths. The switch controller 22 at the receiver reassembles the received portions back into the two video streams. Table 1 below provides an example of how the two streams are scheduled at the two paths. The Left view steam (Stream 1) and Right view steam (Stream 2), are synchronized during the transmission at both paths, Path 1 and Path 2.

TABLE 1
Example of the schedule for multipath transmission

| | Time unit | | | | |
|---|---|---|---|---|---|
| | 1 | 2 | 3 | 4 | . . . |
| At path 1 | Stream 1 | Stream 2 | Stream 1 | Stream 2 | . . . |
| At path 2 | Stream 2 | Stream 1 | Stream 2 | Stream 1 | . . . |

An implementation involves a wireless network according to an embodiment of the invention, including multiple wireless stations (wireless devices) communicating wirelessly via wireless media such as one or more radio frequency (RF) wireless channels. A frame structure may be used for data transmission between the wireless stations. Each wireless station incldues a media access control (MAC) layer and a physical (PHY) layer. In one example, the MAC layer obtains a MAC Service Data Unit (MSDU) and attaches a MAC header thereto, in order to construct a MAC Protocol Data Unit (MPDU), for transmission. The MAC header includes information such as a source address (SA) and a destination address (DA). The MPDU is a part of a PHY Service Data Unit (PSDU) and is transferred to a PHY layer in the transmitter to attach a PHY header (including a PHY preamble as well) thereto to construct a PHY Protocol Data Unit (PPDU). The PHY header includes parameters for determining a transmission scheme including a coding/modulation scheme. Before transmission as a packet from a transmitter to a receiver, a preamble is attached to the PPDU, wherein the preamble can include channel estimation and synchronization information.

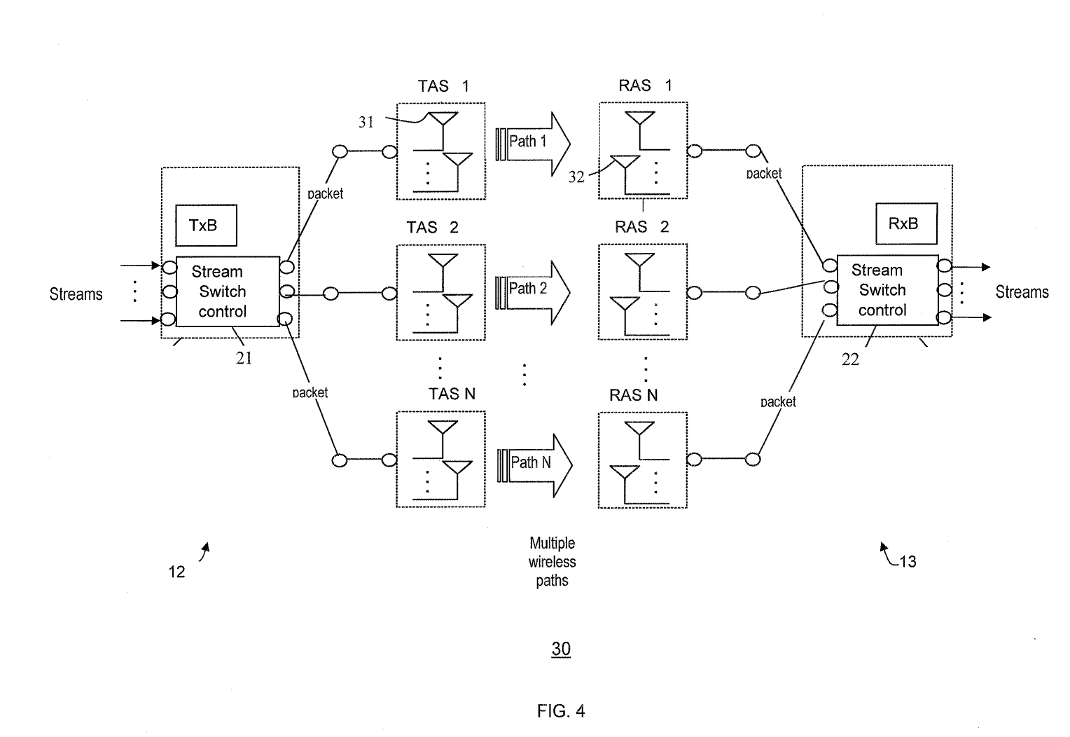

FIG. 4 shows an implementation of multipath transmission architecture 30 for uncompressed 3D video using a frame structure, according to an embodiment of the invention. The wireless transmitter 12 comprises multiple antennas 31. The wireless receiver 13 comprises multiple antennas 32. The switch controller 21 of the transmitter 12 is configured for processing video information into packets and includes a multipath communication module configured for switching (alternating) packets of multiple streams on different transmission paths. The switch controller 22 at the receiver processes the received packets to reassemble them back into the multiple streams for playback (e.g., display). Different transmission paths involve different transmitter and receiver antennas. For example, a first transmission path involves a first transmitter antenna set (TAS 1) and receiver antenna set (RAS 1). Similarly, an N^{th} transmission path involves transmitter antenna set (TAS N) and a receiver antenna set (RAS N). Each video stream comprises plural packets. For each video stream, the transmitter switch controller 21 alternates the stream packets on different transmission paths. As such, two or more packets of each video stream are transmitted on different transmission paths. For example, assume two paths are simultaneously operated between the transmitter 12 and the receiver 13. The first path (Path 1) is between TAS1 and RAS1 and the second path (Path 2) is between TAS2 and RAS2. As shown in Table 1 above, during the time unit 1, the information of the stream 1 is transmitted on Path 1 and the information of the stream 2 is transmitted on Path 2; and during the time unit 2, the switch controller 21 switch the information of two streams, and the information of the stream 2 is transmitted on Path 1 and the information of the stream 1 is transmitted on Path 2; and so on.

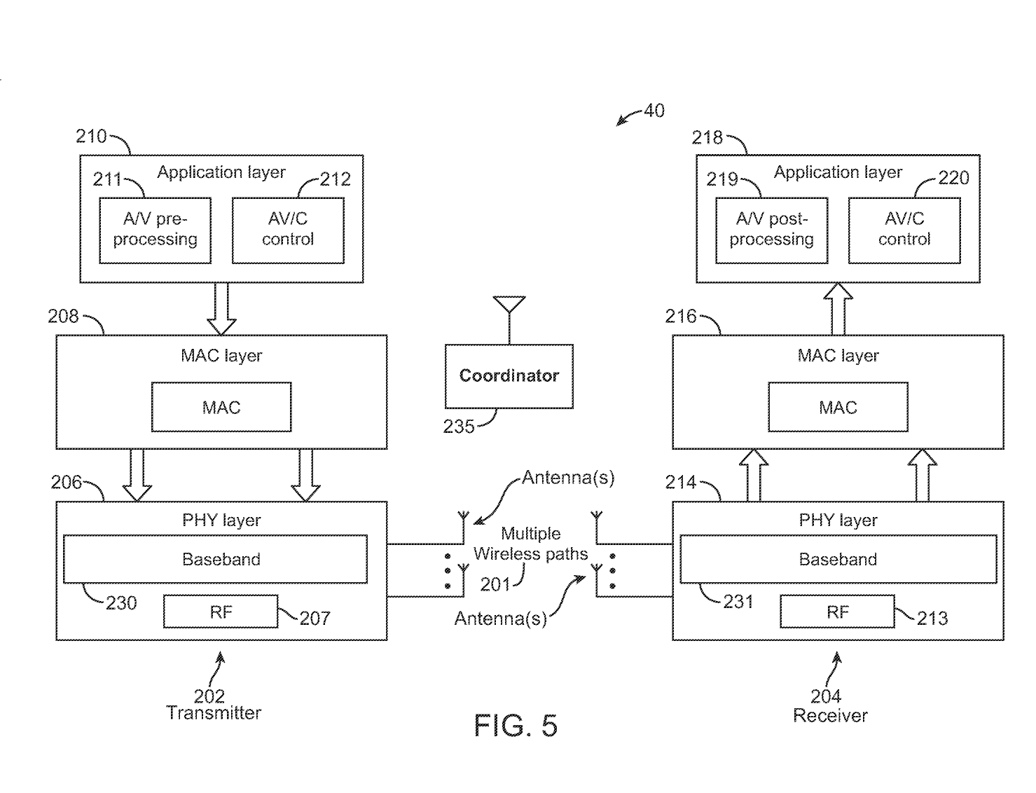

FIG. 5 shows a functional block diagram of an example wireless communication system 40, implementing said multipath transmission system for uncompressed 3D video utilizing a frame structure, according to the present invention. The system 40 includes a wireless transmitter (sender) station 202 and a wireless receiver station 204, for video transmission (the system 40 may also include a coordinator functional module 235 that facilitates video transmissions, such as in infrastructure mode; the coordinator 235 is a logical module that can be implemented as a stand-alone device or as part of the sender or the receiver). The transmitter 202 comprises an example implementation of the transmitter 12 in FIG. 4, and the receiver 204 comprises an example implementation of the receiver 13 in FIG. 4.

The sender 202 includes a PHY layer 206, a MAC layer 208 and an application layer 210. The PHY layer 206 includes a radio frequency (RF) communication module 207 which transmits/receives signals under control of a baseband process module 230, via multiple wireless paths 201. The baseband module 230 allows communicating control information and video information.

The application layer 210 includes an audio/visual (AN) pre-processing module 211 comprising a pixel partitioning module configured for pixel partitioning, and a pixel allocation module configured for pixel allocation involving packetizing streams, as described above. The packets are then converted to MAC packets by the MAC layer 208. The application layer 210 further includes an AV/C control module 212 which sends stream transmission requests and control commands to reserve channel time blocks for transmission of packets according to the pixel partition allocation and transmission process above.

The receiver 204 includes a PHY layer 214, a MAC layer 216 and an application layer 218. The PHY layer 214 includes a RF communication module 213 which transmits/receives signals under control of a baseband process module 231. The application layer 218 includes an A/V post-processing module 219 for de-partitioning and de-packetizing into streams the video information in the MAC packets, received by the MAC layer 216. De-partitioning and de-packetizing are reverse of the partitioning and packetization steps described above. The application layer 218 further includes an AV/C control module 220 which handles stream control and channel access. Beamforming transmissions may be performed over multiple channels. The MAC/PHY layers may perform antenna training and beaming switching control as needed.

An example implementation of the present invention for mmWave wireless such as a 60 GHz frequency band wireless network can be useful with Wireless HD (WiHD) applications. WirelessHD is an industry-led effort to define a wireless digital network interface specification for wireless HD digital signal transmission on the 60 GHz frequency band, e.g., for consumer electronics (CE) and other electronic products. An example WiHD network utilizes a 60 GHz-band mmWave technology to support a physical (PHY) layer data transmission rate of multi-Gbps (gigabits per second), and can be used for transmitting uncompressed high definition television (HDTV) signals wirelessly. Another example application is for ECMA (TC32-TG20), wireless radio standard for very high data rate short range communications (ECMA stands for European Computer Manufacturers Association, which provides for international standards association for information and communication systems). The present invention is useful with other wireless communication systems as well, such as IEEE 802.15.3c.

In addition to mmWave wireless applications discussed above, a spatial partitioning process according to the present invention is applicable to other wireless technologies which use beamforming or directional transmission. Such other wireless technologies include an IEEE 802.11n wireless local area network (WLAN). Further, the present invention is applicable to certain compressed video streams in the format of multiple description coding (MDC) and layered coding.

The transmitter MAC layer 208 implements said stream switch controller 21 (FIG. 4) for switching stream packets on different wireless transmission paths, and the receiver MAC layer 216 of the receiver performs stream switch controller 22 (FIG. 4) for processing the received packets into multiple streams for playback.

Scheduling specifies the duration of a wireless channel time unit which dictates how frequently to switch the streams on the multiple transmission paths. The duration of the time unit can be variable; however, in one implementation the duration is set to a fixed value. The duration of the time unit can be of one or multiple video frames, or part of a video frame such as one or multiple video frame pixel lines.

When video pixel packetization is utilized, a time unit can be one or multiple packets. The packetization scheme is adapted to the path switching mechanism and path bandwidth capacity status. When different transmission paths have different bandwidth capacities, the paths transmit different amounts of stream bits during the same time unit.

Using a multipath transmission scheme according to the invention, even if a path is blocked temporarily, at least a portion of the stream packets arrive at the receiver successfully on other paths using scalable rate adaptation schemes, as described below.

More than one path may have link quality degradation during the 3D transmission. Scalable rate adaptation allows maintaining synchronization between the video streams, wherein processing of the video streams implements the same rate adaptation scheme, and keeps the same data rate, per stream during multipath transmission. As such, the multiple streams are synchronized during transmission from the transmitter and during and playback at the receiver. Scalable rate adaptation may be implemented in the MAC layers of the transmitter and the receiver.

A high speed rate adaptation process for an uncompressed 3D video multipath transmission system, according to an embodiment of the invention is described below. For each stream, in a stream packetization process, stream pixel partitioning is performed during the packetization wherein video pixels belonging to different partitions are put into different packets. In one example, a process for partitioning video pixels at a wireless transmitter, involves: inputting a video frame comprising multiple pixels; determining a number of partitions k; partitioning the frame of pixels into k different partitions; constructing a MAC packet for each partition (i.e., packetizing); and, placing pixels of each partition into a corresponding MAC packet.

In one implementation, an uncompressed video frame includes a set of pixels. The spatial location of each pixel in a rectangular video frame can be identified by a column index m (horizontal), and a row index n (vertical). Each of the indices m and n can take on integer values 0, 1, 2, 3, 4, etc. The pixels are split horizontally into two groups: (1) the first group of pixels have indices m=0, 2, 4, . . . , etc., per line and indices n=0, 1, 2, . . . , etc.; and (2) the second group of pixels have indices m=1, 3, 5, . . . , etc., per line and indices n=0, 1, 2, . . . , etc. Then, pixels from the first group are placed in a first packet (e.g., Packet 0), and pixels from the second group are placed in a second packet (e.g., Packet 1). Therefore, one or more pixels of the first group are placed in the Packet 0, and one or more pixels of the second group are placed in the Packet 1. As a result, spatially neighboring pixels are partitioned and placed into different packets. Packet size is selected depending on transmitter and receiver buffer requirements. One or more lines worth of pixels can be placed in each packet. A cyclic redundancy check (CRC) for each packet may be computed and appended at the end of the packet before transmission to a receiver over a wireless channel.

After pixel partitioning, in each packet which represents a pixel partition, the bits are re-organized according to bit-planes. For example, if one color element of a pixel has 8 bits, all the 8th bits of different pixels are grouped together, and then the 7th bits, and so on.

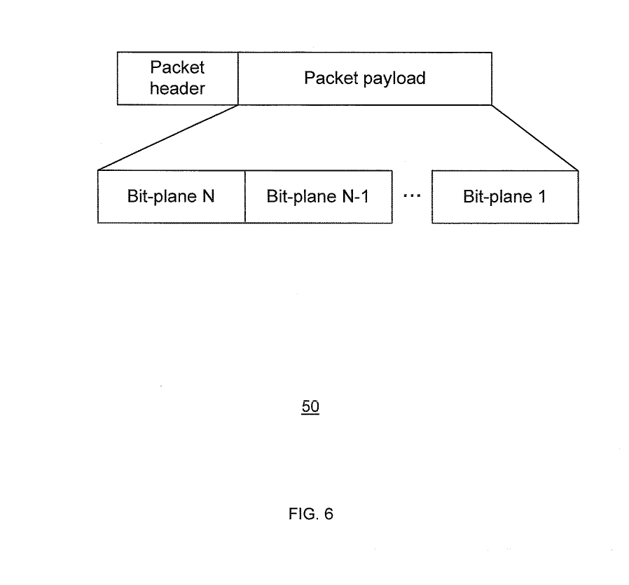

An example packet structure 50 for each individual video stream to ease rate adaptation is shown in FIG. 6, according to an embodiment of the invention. Each packet payload is divided into different bit-planes (e.g., Bit-plane 1, . . . , Bit-plane N, where N is the total number of bit-planes for each color component). Certain packets (or video information in certain packets) can be dropped to achieve transmission rate adaptation by dropping pixel partitions. Certain bit-planes can be dropped to achieve transmission rate adaptation, such as by dropping least significant bit (LSB) information.

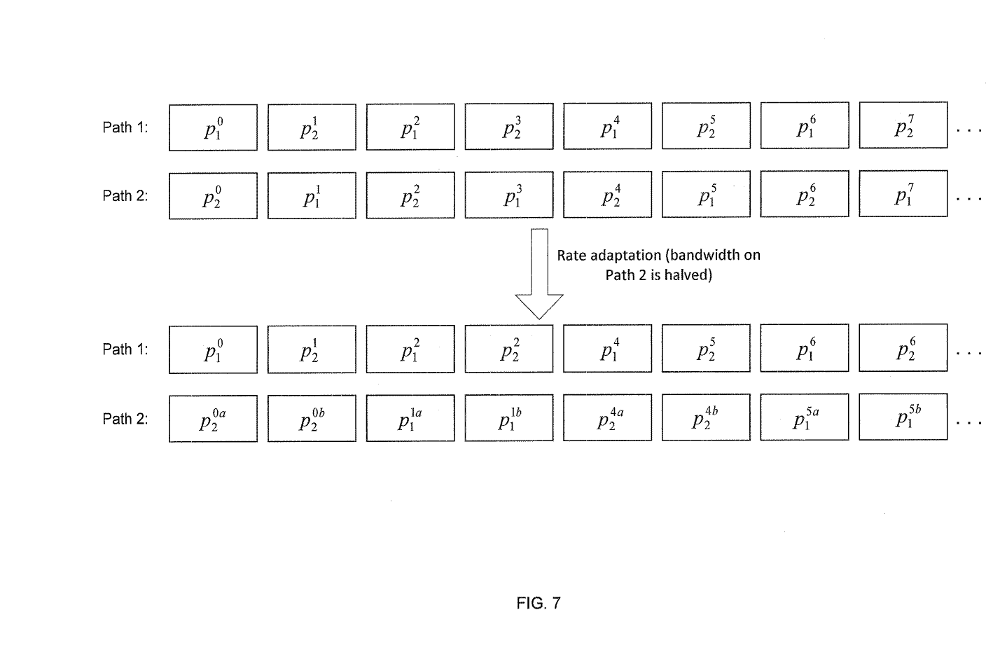

For example, for a packet denoted as pᵢ^{j} where i (i=1 or 2) is the stream index and j (j>=0) is the packet number, the value of (j mode 4) is the pixel-partitioning index if k=4 partitions are applied. FIG. 7 shows a two path transmission example (Path 1, Path 2) according to an embodiment of the invention, illustrating how the video stream packets are scheduled based on transmission rate adaptation when the bandwidth of Path 2 is halved (e.g., transmission rate reduction due to link quality issues or blockage). The fourth partition packet pᵢ^{4k-1} (k≧1, i=1,2) of each stream is dropped. Each packet pᵢ^{j} at Path 2 is split into two packets pᵢ^{ja} and pᵢ^{jb} to keep the same duration of time unit as a packet in Path 1. The packet order at Path 1 is p₁^{4k-4}, p₂^{4k-3}, p₁^{4k-2}, p₂^{4k-2}, . . . ; with (k≧1). The packet order at Path 2 is p₂^{(4k-4)a}, p₂^{(4k-4)b}, p₁^{(4k-3)a}, p₁^{(4k-3b)b}, . . . ; with (k≧1). The two streams still keep synchronized while being transmitted alternatively at the two paths after the bandwidth of Path 2 is halved.

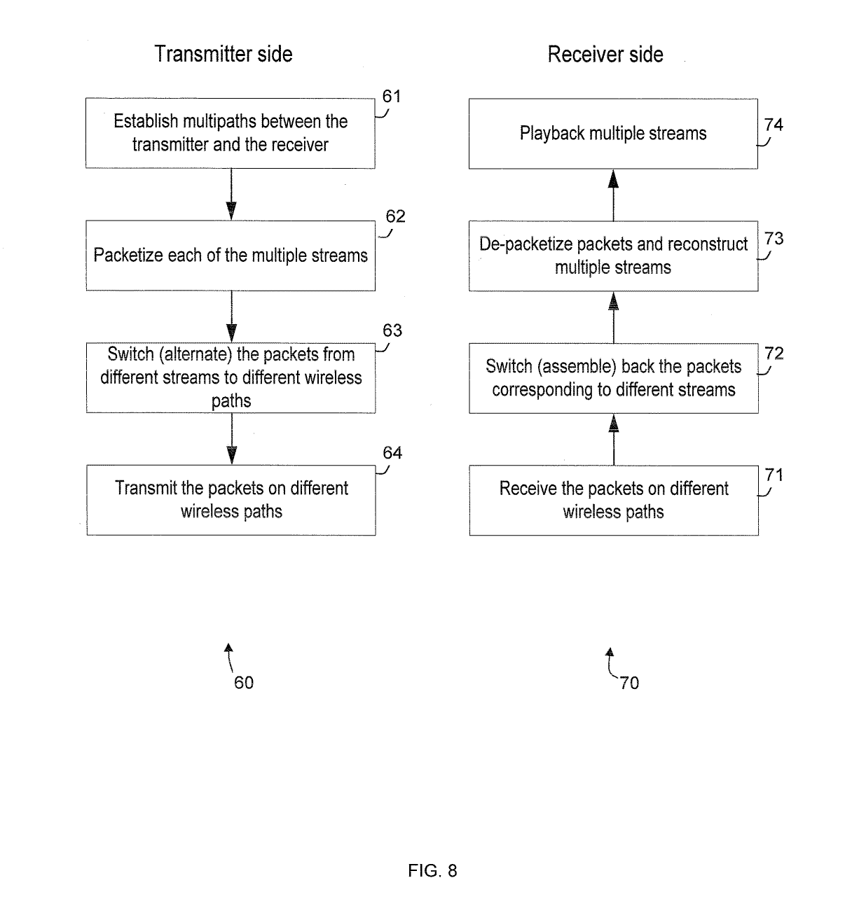

FIG. 8 shows an example of overall communication processes performed by the transmitter and the receiver involving simultaneous multipath wireless communication process for wireless communication of 3D video information, according to an embodiment of the invention. A multipath video transmission process 60 at the wireless transmitter comprises the following processing blocks:

Block 61: Establish multipaths between the transmitter and the receiver.

Block 62: Packetize each of the multiple streams.

Block 63: Switch (alternate) the packets from different streams to different paths.

Block 64: Transmit the packets on different paths.

A multipath video receiving process 70 at the wireless receiver comprises the following processing blocks:

Block 71: Receive the packets on different wireless paths.

Block 72: Switch (assemble) back the packets corresponding to different streams.

Block 73: De-packetize packets and reconstruct multiple streams.

Block 74: Playback multiple streams.

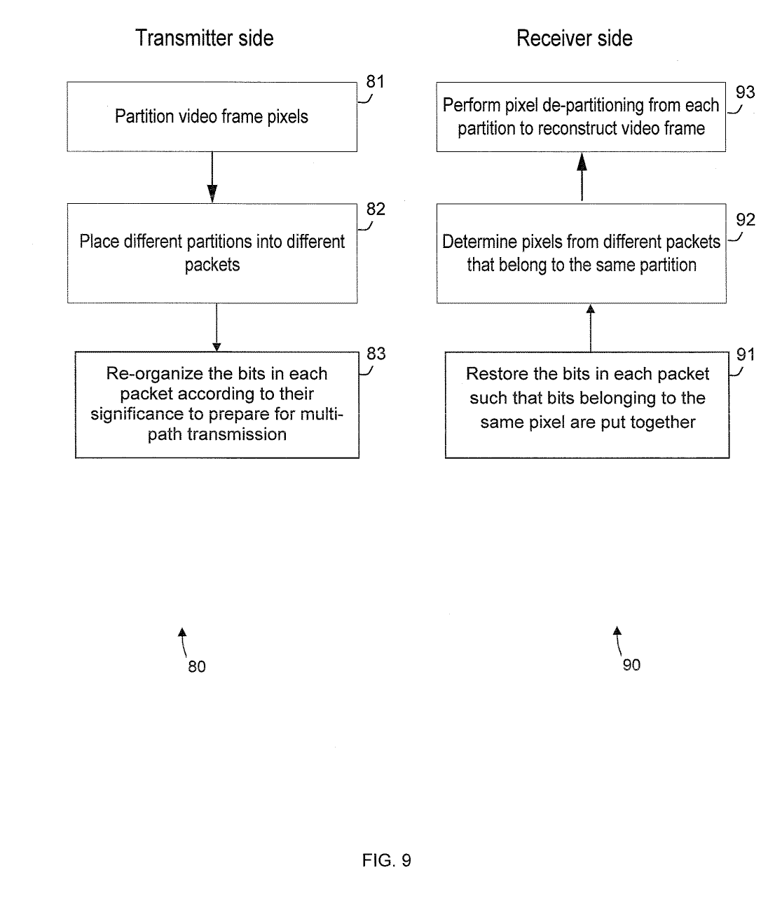

FIG. 9 shows an example of video frame pixel packetization at the transmitter and de-packetization at the receiver, involved in the simultaneous multipath communication process for wireless communication of 3D video information, according to an embodiment of the invention. A packetization process 80 at the wireless transmitter comprises the following processing blocks:

Block 81: Partition video frame pixels.

Block 82: Place different partitions into different packets.

Block 83: Re-organize the bits in each packet according to their significance (i.e., most significant bits are put at the beginning of the packets followed by the less significant bits).

A de-packetization process 90 at the wireless receiver comprises the following processing blocks:

Block 91: Restore the bits in each packet such that bits belonging to the same pixel are put together.

Block 92: Determine pixels from different packets that belong to the same partition.

Block 93: Perform pixel de-partitioning from each partition to reconstruct video frame.

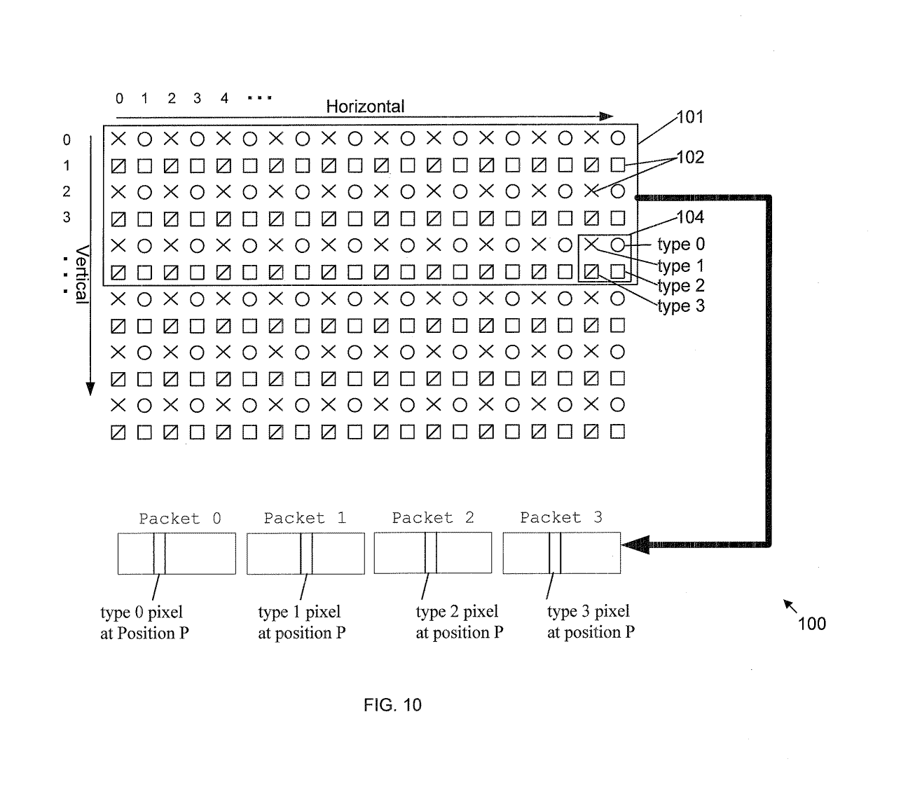

FIG. 10 shows an example of packetization according to an embodiment of the invention. As noted, in an uncompressed video frame, geographically neighboring (spatially correlated) pixels usually have very similar, or even the same values. Regardless of how pixel partitioning is performed, so long as spatially neighboring pixels are partitioned and placed into different packets for transmission, then if pixel information in a received packet is corrupted (i.e., lost or damaged), one or more other packets which contain pixels that are spatially related to the corrupt pixel(s) can be used to recover (compensate for) the corrupt pixel information.

Preferably, partitioning is performed such that pixels with minimal spatial distance are placed into different packets for transmission over a wireless channel. Further, partitioning can be performed by distributing y number of spatially correlated pixels into z number of different packets, wherein y≠z. In one example, y can be greater than z, whereby at least one of the packets includes two or more spatially correlated (neighboring) pixels from a partition. It is also possible to split pixels vertically. However, for an interlaced format, since two neighboring lines are already split into two separate fields, it is preferable to partition horizontally for each field if only two partitions are required.

FIG. 10 shows an example application 100 for partitioning a frame 101 of pixels 102, and packetizing for K=4 partitions. In this example, the pixels are split into four types (i.e., types 0, 1, 2, 3) of 2×2 blocks 104, wherein K=4 pixels per block. The four pixels in each 2×2 block 104 are placed into four (4) different packets (i.e., Packets 0, 1, 2, 3) as shown. Pixels with minimal spatial distance are placed into different packets for transmission.

Specifically, for the type 0 pixels (i.e., partition 0), the indices i and j are even numbers (i.e., i=0, 2, 4, . . . , etc., and j=0, 2, 4, . . . , etc.), and the type 0 pixels are placed in the Packet 0. For the type 1 pixels (i.e., partition 1), the index i is odd (i.e., i=1, 3, 5, . . . , etc.), the index j is even (i.e., j=0, 2, 4, . . . , etc.), and the type 1 pixels are placed in the Packet 1. For the type 2 pixels (i.e., partition 2), the index i is even (i.e., i=0, 2, 4, . . . , etc.), the index j is odd (i.e., j=1, 3, 5, . . . , etc.), and the type 2 pixels are placed in the Packet 2. For the type 3 pixels (i.e., partition 3), the indices i and j are odd numbers (i.e., i=1, 3, 5, . . . , etc., and j=1, 3, 5, . . . , etc.), and the type 3 pixels are placed in the Packet 3. A cyclic redundancy check (CRC) value for each packet may be appended at the end of the packet before transmission to a receiver of a wireless channel.

In general, square/rectangular blocks 104 (each block including multiple pixels therein), can be used for partitioning the multiple pixels in each block into corresponding multiple packets, wherein for each block, preferably each pixel in that block is placed in a different packet for transmission. Different packets can be transmitted at a single channel or at different paths. In addition to robustness improvement, in the case when one channel/path cannot meet the bandwidth requirement for an uncompressed video stream, spatial pixel partitioning can take advantage of multi-channels/paths to transmit all data of an uncompressed video stream.

Now referring back to FIG. 4 in conjunction with FIG. 10, switching control functions 21 and 22 allow packet assignments to multiple paths based on path (channel) conditions. Channel conditions includes available bandwidth (i.e., the data rate that a channel can support), the channel quality (e.g., signal-to-noise-ratio), bit error rate or packet error rate), etc. If the channel quality can satisfy the video transmission requirement, then the transmitter determines how many pixel partitions to allocate to the channel based on the available channel bandwidth.

In the case of beam steering, at the antenna training stage, a beam (i.e., wireless path) candidate table (TxB) is generated at the transmitter 12 and a corresponding beam candidate table (RxB) at the receiver 13. Each beam candidate entry in a beam candidate table includes a beam index number and related antenna configuration information. Table 2 below show entries of example beam candidate table TxB:

TABLE 2
Transmitter Beam Candidate Table

| | | Antenna |
|---|---|---|
| Beam Candidate | Beam Index | Configuration |
| (BC) | (BI) | Info. (ACI) |
| BC | TxB_1 | ACI_1 |
| . | . | . |
| . | . | . |
| . | . | . |
| BC | TxB_N | ACI_N |

Table 3 below show entries of example beam candidate table RxB:

TABLE 3
Receiver Beam Candidate Table

| | | Antenna |
|---|---|---|
| Beam Candidate | Beam Index | Configuration |
| (BC) | (BI) | Info. (ACI) |
| BC | RxB_1 | ACI_1 |
| . | . | . |
| . | . | . |
| . | . | . |
| BC | RxB_N | ACI_N |

The beam candidates (BCs) in the tables are ordered according to beam quality (e.g., a beam indexed as TxB_m, RxB_n has better channel quality than a beam indexed as TxB_m, RxB_n, if m<n). Beam candidate tables at the transmitter/receiver are updated periodically to reflect the dynamic beam channel conditions between the transmitter and the receiver. The TxB table and the RxB table have corresponding entries.

According to the TxB and RxB table entries, the antenna configuration information for each candidate beam specifies a set (combination) TAS of the transmitter antennas 31, and a set (combination) RAS of receiver antennas 32. This provides multiple logical or physical antenna sets TAS at the transmitter side 12, including: TAS 1, . . . , TAS N. There are also multiple logical or physical antenna sets RAS at the receiver side 13, including: RAS 1, . . . , RAS N.

If the antenna configuration ACI can be determined in a short time period (e.g., less than about 10 to 20 microseconds), the same transmitter antenna combinations can be used by different sets TAS, and the same receiver antenna combinations can be used by the sets RAS. Otherwise, the antennas are physically divided and assigned to different antenna sets TAS and RAS, respectively.

In one example, during an antenna training stage, TAS 1 and RAS 1 find a best beam (first beam path) with each other, then TAS 2 and RAS 2 find a good alternative beam (second beam) with each other under the constraint that the alternative beam is far away in beam pointing direction from the best beam. Depending on the conditions of the first and second beam paths, there are several possible ways to allocate the video data on the two beam paths, as described above (e.g., FIG. 7). Stream packets may alternate evenly between multiple beam paths based on path conditions. For example, during an antenna training stage, if two beams (i.e., primary beam path Beam 1 and secondary beam path Beam 2), have similar channel conditions, then packets Packet 0, Packet 1, Packet 2 and Packet 3 (FIG. 10) can be evenly alternated between two beams.

Stream packets may alternate evenly between multiple beam paths, or unevenly as needed based on path conditions. For example, if during the antenna training stage, the beams have different channel conditions and bandwidth capacities, then the multiple stream packets are unevenly alternated to the beam paths.

During the wirelesss video transmission stage, the alternating plural packets to multiple beam paths can be dynamically adjusted using switching control functions 21, 22, according to the actual channel conditions of the beam paths.

Further, during the wireless video transmission stage, dropping video information can be dynamically adjusted such that certain packets (or video information in certain packets) can be dropped to achieve transmission rate adaptation by dropping pixel partitions (e.g., FIG. 7). As noted, certain bit-planes can be dropped to achieve transmission rate adaptation, such as by dropping least significant bit (LSB) information. A dropping function can be implemented before switching control function 21 or together with the switching control function 21.

At the receiver, the video information dropped by the transmitter for rate adaptation may be reconstructed using received video information. In one example (e.g., K=2 partitions), reconstructing a dropped pixel includes replacing dropped pixel in a packet, with a corresponding pixel of an adjacent packet. In another example (e.g., K=4 partitions), reconstructing a dropped pixel includes replacing the dropped pixel in a packet with the average value of the neighboring pixels of an adjacent packet. Other approaches for reconstructing a dropped pixel may be utilized. If a pixel in one packet (e.g., Packet 0) is dropped, then spatially related pixels in the other three packets (e.g., Packets 1, 2 or 3) can be used at the receiver to compensate for the dropped pixel. As such, if pixel information in position P in a packet (e.g., Packet 0) is dropped, then the pixel information in position P in other spatially related packets (e.g., Packets 1, 2 or 3) can be used to compensate for the dropped video information.

As such, the neighboring pixels in a video frame are partitioned to different packets and each packet is transmitted separately over a wireless channel. If video information for a packet is dropped at the transmitter, or during transmission, data in other packets carrying the neighboring pixels can be used to recover the dropped/lost pixels.

High quality audio usually has multiple audio channels. During transmission, similar to the 3D video, multiple audio streams are synchronized during transmission and playback, according to an embodiment of the invention. The techniques described above can be applied to multi-channel (multi-stream) audio, as those skilled in the art will recognize. For audio, multi-channel (multi-stream) separation corresponds to pixel partitioning for video in terminology.

As such, an embodiment of the invention provides a 60 GHz multipath transmission mechanism for uncompressed 3D video. Simultaneous multipath transmission allows two uncompressed video streams corresponding to the left-eye view and right-eye view to be strictly synchronized during transmission and playback. Scalable link adaptation is provided without negatively affecting synchronization between the two streams.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, etc. The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer, processing device, or any instruction execution system. For the purposes of this description, a computer-usable or computer readable medium can be any apparatus that can contain, store, communicate, or transport the program for use by or in connection with the instruction execution system, apparatus, or device. The medium can be electronic, magnetic, optical, or a semiconductor system (or apparatus or device). Examples of a computer-readable medium include, but are not limited to, a semiconductor or solid state memory, magnetic tape, a removable computer diskette, a RAM, a read-only memory (ROM), a rigid magnetic disk, an optical disk, etc. Current examples of optical disks include compact disk-read-only memory (CD-ROM), compact disk-read/write (CD-R/W) and DVD.

I/O devices (including but not limited to keyboards, displays, pointing devices, etc.) can be connected to the system either directly or through intervening controllers. Network adapters may also be connected to the system to enable the data processing system to become connected to other data processing systems or remote printers or storage devices through intervening private or public networks. Modems, cable modem and Ethernet cards are just a few of the currently available types of network adapters. In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

The terms “computer program medium,” “computer usable medium,” “computer readable medium,” and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information, from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor or multi-core processor to perform the features of the computer system. Accordingly, such computer programs represent controllers of the computer system.

Generally, the term “computer-readable medium”, as used herein, refers to any medium that participated in providing instructions to a processor for execution. Such a medium may take many forms, including but not limited to, non-volatile media, volatile media and transmission media. Non-volatile media includes, for example, optical or magnetic disks, such as a storage device. Volatile media includes dynamic memory, such as a main memory. Transmission media includes coaxial cables, copper wire and fiber optics, including the wires that comprise a bus. Transmission media can also take the form of acoustic or light waves, such as those generated during radio wave and infrared data communications.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of transmitting plural synchronous video streams over multiple wireless paths, comprising:
for each video stream, partitioning spatially correlated pixels into different partitions, and placing pixels from different partitions into different packets; and
performing multipath transmission of the plural video streams by alternating transmission of packets from each video stream over multiple paths, while maintaining video information for the plural video streams synchronized during transmission.

2. The method of claim 1 further comprising performing rate adaptation by determining when different transmission paths have different bandwidth capacities, wherein different paths may have same bandwidth capacities, and transmitting different amounts of video over different paths during the same time unit based on bandwidth capacity of each path, while maintaining the video streams synchronized during transmission.

3. The method of claim 2 further comprising: maintaining the video streams synchronized during transmission from a wireless transmitter and during playback at a wireless receiver; and
reconstructing the video streams from the received packets, such that the reconstructed video streams are synchronized.

4. The method of claim 3 wherein the video streams comprise three-dimensional video information with a right-eye stream and a left-eye stream, such that the video streams are synchronized during transmission from the wireless transmitter and during playback at a wireless receiver whereby at time t, if the kth line of the ith video frame of the left-eye stream is being played backed at the receiver, then the kth line of the ith video frame of the right-eye stream must be played back at the receiver at the same time.

5. The method of claim 4 wherein the multiple paths comprise multiple spatially separated paths.

6. The method of claim 5 further comprising employing scheduling to specify the duration of each time unit which dictates how frequently the packets are alternated on the different paths, wherein the duration of each time unit may be variable.

7. The method of claim 6 wherein duration of a time unit is based at least one of: one or multiple video frames, and part of a video frame comprising one or multiple video pixel lines.

8. The method of claim 7 wherein said adapting further comprises dropping certain pixel partitions to achieve rate adaptation for paths with reduced bandwidth capacity.

9. The method of claim 8 wherein:
spatially correlated pixels are partitioned such that spatially neighboring pixels are partitioned and placed into different packets, and in each packet which represents a pixel partition, the bits are re-organized according to bit-planes; and
dropping certain pixel partitions includes dropping least significant bit (LSB) bit planes for rate adaptation.

10. A wireless station for transmitting plural synchronous video streams over multiple wireless paths, comprising:
a processing module comprising:
a spatial portioning module configured for processing each video stream by partitioning spatially correlated pixels into different partitions, and
a pixel allocation module configured for placing pixels from different partitions into different packets; and
a multipath communication module configured for multipath transmission of the plural video streams by alternating transmission of packets from each video stream over multiple paths, while maintaining video information for the plural video streams synchronized during transmission.

11. The wireless station of claim 10 wherein the processing module is further configured for performing rate adaptation by determining when different transmission paths have different bandwidth capacities, wherein different paths may have same bandwidth capacities, for transmitting different amounts of video over different paths during the same time unit based on bandwidth capacity of each path, while maintaining the video streams synchronized during transmission.

12. The wireless station of claim 11 wherein the processing module is further configured for maintaining the video streams synchronized during transmission for synchronized playback at a receiving wireless station.

13. The wireless station of claim 12 wherein the video streams comprise three-dimensional video information with a right-eye stream and a left-eye stream, such that the video streams are synchronized during transmission and during playback at a receiving wireless station, whereby at time t, if the kth line of the ith video frame of the left-eye stream is being played backed at the receiver, then the kth line of the ith video frame of the right-eye stream must be played back at the receiving wireless station at the same time.

14. The wireless station of claim 13 wherein the multiple paths comprise multiple spatially separated paths.

15. The wireless station of claim 14 wherein the processing module is further configured for scheduling to specify the duration of each time unit which dictates how frequently the packets are alternated on the different paths, wherein the duration of each time unit may be variable.

16. The wireless station of claim 15 wherein duration of a time unit is based at least one of: one or multiple video frames, and part of a video frame comprising one or multiple video pixel lines.

17. The wireless station of claim 16 wherein said adapting further comprises dropping certain pixel partitions to achieve rate adaptation for paths with reduced bandwidth capacity.

18. The wireless station of claim 17 further comprising a reconstruction module configured for reconstructing video streams from received packets, such that the reconstructed video streams are synchronized.

19. A wireless system for communication of plural synchronous video streams over multiple wireless paths, comprising:
a wireless transmitter and a wireless receiver;
the transmitter including:
a processing module comprising:
a spatial portioning module configured for processing each video stream by partitioning spatially correlated pixels into different partitions, and
a pixel allocation module configured for placing pixels from different partitions into different packets; and
a multipath communication module configured for multipath transmission of the plural video streams by alternating transmission of packets from each video stream over multiple paths, while maintaining video information for the plural video streams synchronized during transmission;
the receiver comprising a reconstruction module configured for reconstructing video streams from received packets, such that the reconstructed video streams are synchronized.

20. The system of claim 19 wherein the processing module is further configured for performing rate adaptation by determining when different transmission paths have different bandwidth capacities, wherein different paths may have same bandwidth capacities, for transmitting different amounts of video over different paths during the same time unit based on bandwidth capacity of each path, while maintaining the video streams synchronized during transmission.

21. The system of claim 20 wherein the processing module is further configured for maintaining the video streams synchronized during transmission for synchronized playback at the receiver.

22. The system of claim 21 wherein the video streams comprise three-dimensional video information with a right-eye stream and a left-eye stream, such that the video streams are synchronized during transmission and during playback at the receiver, whereby at time t, if the kth line of the ith video frame of the left-eye stream is being played backed at the receiver, then the kth line of the ith video frame of the right-eye stream must be played back at the receiver at the same time.

23. The system of claim 22 wherein the multiple paths comprise multiple spatially separated paths.

24. The system of claim 23 wherein the processing module is further configured for scheduling to specify the duration of each time unit which dictates how frequently the packets are alternated on the different paths, wherein the duration of each time unit may be variable.

25. The system of claim 24 wherein duration of a time unit is based at least one of: one or multiple video frames, and part of a video frame comprising one or multiple video pixel lines.
